(19) United States
(12) Patent Application Publication
(10) Pub. No.: US 2009/0154814 A1
(43) Pub. Date: Jun. 18, 2009

(54) CLASSIFYING OBJECTS USING PARTITIONS AND MACHINE VISION TECHNIQUES

(76) Inventor: Y'aakov Ben Natan, Kfar Vradim (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 11/954,727

(22) Filed: Dec. 12, 2007

(51) Int. Cl. G06K 9/62

(52) U.S. Cl. 382/224

(57) ABSTRACT

A method for classifying objects according to a predefined classification of sample objects. This is achieved by classifying first a plurality of sample object images and determining an image partition for each and every class. The sample classes and their corresponding partitions are used to build a classifying function. The classifying function is built using the partitions and the geometric features and statistical information retrieved from the sample images. In order to classify a specific object, several image copies of the object image to-be-classified are prepared; each image copy is then partitioned according to a different classified-in-advance partition. The classifying is achieved by applying the classifying function that has been built on the object image copies.

### FIELD OF THE INVENTION

The present invention relates generally to a method for classifying objects and more particularly to a method for classifying objects using machine vision and machine learning techniques.

### BACKGROUND OF THE INVENTION

Computerized objects classification systems have been an ongoing challenge for machine vision specialists for many years. Object classification is a very suitable task for both machine vision and machine learning techniques and as objects classification has always been a tedious task, the motivation to develop an efficient computerized visual classification method is clear.

Generally, machine vision techniques enable to analyze digital images of objects by deriving quantitative parameters from the geometrical features and statistical spatial information of these images. Currently available classifying algorithms process the information gathered from all the object images and employ a decision-making function to decide to which class a certain object to-be-classified belongs. Some of these algorithms are imitating the way human beings think, sometimes by employing fuzzy logic or neural network concepts.

Specifically, many of the machine vision solutions for classifying objects available today suggest a two-steps classification process. In the first step, the image of the object to-be-classified is segmented into an object and its background. In the second step the object is further segmented into sub objects allowing quantitative data to be extracted from each sub object and to form a total assessment of the object so that it may serve as a basis for classification.

### SUMMARY OF THE INVENTION

Whereas many of the currently available methods for classifying objects focus mainly on the above-mentioned second segmentation step, the present invention bypasses the usual challenges affiliated with this step. This is achieved by first classifying manually a plurality of sample object images and determining an image partition that is representative for each and every class. Then, the sample classes and their corresponding partitions are used to build a classifying function. In order to classify a specific object, several image copies of the object image to-be-classified are prepared; each image copy is then partitioned according to a different classified-in-advance partition. The classification is achieved by applying the built classifying function on the object image copies.

Specifically, the suggested classifying method begins with classifying manually (or using existing methods) N sample object images into M classes. Then, Q image partitions are determined wherein usually Q=M so that each partition corresponds to a different class wherein each partition divides the image into P sub images. Using the partitions and the samples classification, a classifying function is built based upon the image partitions. Specifically, the classifying function is configured to determine the class of an object image presented to it by analyzing the geometric features and statistical information extracted from all the partitioned images presented to the function. Whenever an image is classified using the method according to the invention, Q object image copies of the object-to-be-classified are prepared. Then, each said object image copy is partitioned in accordance with a different partition, into sub images. The class of the object to-be-classified is determined by applying the classifying function on said partitioned object images copies. The classifying function selects the object image copy whose partition represents the most probable object class.

In some embodiments, the geometric features and the statistical information are extracted from the object images and its sub images by employing image processing functions.

In other embodiments, the classifying function may comprise a learning algorithm instructed to relate geometric features and statistical information retrieved frown the sub images of a specific image copy divided by a specific partition, with a specific object class.

In other embodiments, the classifying function may involve parallel decision making algorithms such as neural networks, support vector machines, decision trees and the like.

### BRIEF DESCRIPTION OF DRAWINGS

The subject matter regarded as the invention will become more clearly understood in light of the ensuing description of embodiments herein, given by way of example and for purposes of illustrative discussion of the present invention only, with reference to the accompanying drawings (Figures, or simply “FIGS.”), wherein:

FIG. 1 presents an object that may be applicable to the classification process according to the present invention;

FIG. 2 is flowchart describing the method according to some embodiments of the present invention;

FIG. 3 presents three classes of object of FIG. 1, and their corresponding partitions as may be applicable according to the present invention;

FIG. 4 presents three copies of the object of FIG. 1, each with a different partitioning based upon the partitions presented in FIG. 3 as may be applicable according to the present invention;

FIG. 5 presents three classes of another object that may be the subject of the classification process according to the present invention and their corresponding partitions; and

FIG. 6 presents three classes of yet another object that may be the subject of the classification process according to the present invention and their corresponding partitions.

### DETAILED DESCRIPTION OF THE INVENTION

In the following description, some terminology is used in general to describe certain features of the present invention as follows:

“Object to-be-classified” is the subject of the classification process according to the present invention.

“Object classes” or “object class images” are the predefined classes of objects according to which the classification is performed. Usually these are object images that have been chosen in advance, with many images, hundreds or thousands representing a different object class.

The method according to the present invention replaces the above-mentioned classic two-steps machine vision classifying methods. As mentioned above, according to the two steps method, classification process has two consecutive segmentations. The first segmentation is done by binarization of the object from its background and second segmentation of the object into sub objects. The disclosed method replaces the second segmentation with a multiple partitions-based process. For means of demonstration only, the method according to the present invention retains the use of binarization in colors to perform the initial segmentation to the object and its background. It may be clear that other object/background segmentation methods may also be used to perform tile first segmentation step.

The present invention discloses a novel method for classifying objects. Classifying a specific object begins with classifying N sample object images of the same kind into M classes. Then, Q image partitions are determined wherein each partition corresponds to a different class and each partition divides the image into sub images. Using the partitions and the samples classification, a classifying function is built based upon the image partitions, wherein the classifying function is configured to determine the class of an object image presented to it by analyzing its geometric features and statistical information. Whenever an image is classified using the method according to the invention, Q object image copies of the object-to-be-classified are prepared. Then, each said object image copy is partitioned into sub images, in accordance with said partitions. Finally, the class of the object to-be-classified is determined by applying the classifying function on data extracted from all partitioned object images copies.

According to other embodiments of the invention, the classification of object image samples is performed manually, by human beings, usually trained individuals or experts in the specific classifying process. These individuals are classifying the object image samples not necessarily according to measurable parameters, rather, according to the general feel regarding the correct class.

According to some embodiments, the partition of the object image samples is performed according to at least one classifying parameter. Alternatively, the partition is performed manually according to the general feel of the expert individuals who perform the partition. In a similar way, fuzzy logic algorithms may be used to achieve a human-like partition. The number of sub images in each partition may be different, according to the classification parameter, and so do the shape of the sub image. Specifically, sub images may be identical or non-identical, polygonal or non-polygonal and overlapping or non-overlapping.

According to other embodiments of the invention, the partition may be in a form of a grid. The grid partition may be in use for classifying according to the number of certain sub objects. The partition may also comprise at least two partition lines defining an angle between them. This partition may be used for classifying according to certain angle-between-sub-objects.

According to other embodiments of the invention, the classifying function is a learning algorithm instructed to relate geometric features and statistical information extracted from the sub images of a specific image copy divided by a specific partition, with a specific object class. The classifying function may employ several decision making algorithms such as neural networks, support vector machines, decision trees and the like.

According to other embodiments of the invention the geometric features and statistical information are retrieved from the image copies and sub images by using image processing functions. These functions may include width, height, area, number of holes, moments of pixel colours, hue, saturation and the like. Additionally, these functions may be imported from at least one third party image processing functions library.

According to other embodiments of the invention, after each object to-be-classified has been classified the decision function is updated with the new data and possibly, a manual feedback as to it success in classifying the object. This process is referred to as “on-line learning”. It should be noted in this context that although off-line learning may yield lesser results but is less time consuming. Additionally, the problem of collecting real-time responses of the workers near the machine regarding the performance of the classification does not exist.

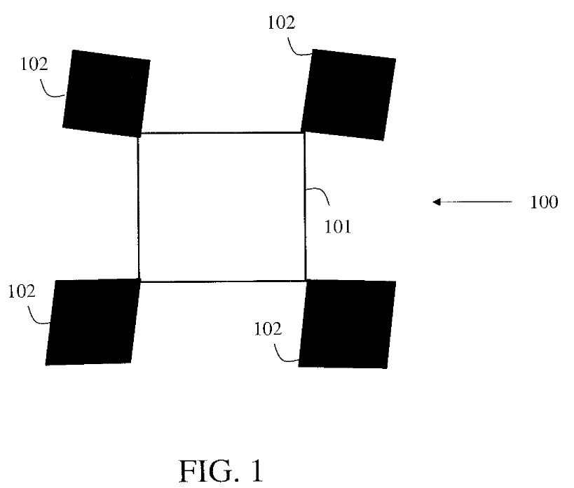

Referring to FIG. 1, an object that may be the subject of the classification process according the present invention is presented, hereinafter referred to as ‘Object A’ 100. Object A 100 comprises one white rectangle 101 and a plurality of black rhombuses 102, that range between two to four, the one shown has four of them. The black rhombuses 102 are an example of sub object of the object A, and so do the white rectangle 101.

According to some embodiments of the present invention, classifying object A may be done according to predefined parameter or any other predefined requirements that are not necessarily measurable. In the following example, the parameter oil which the classifying is based upon is the number of black rhombuses 102 per each object A.

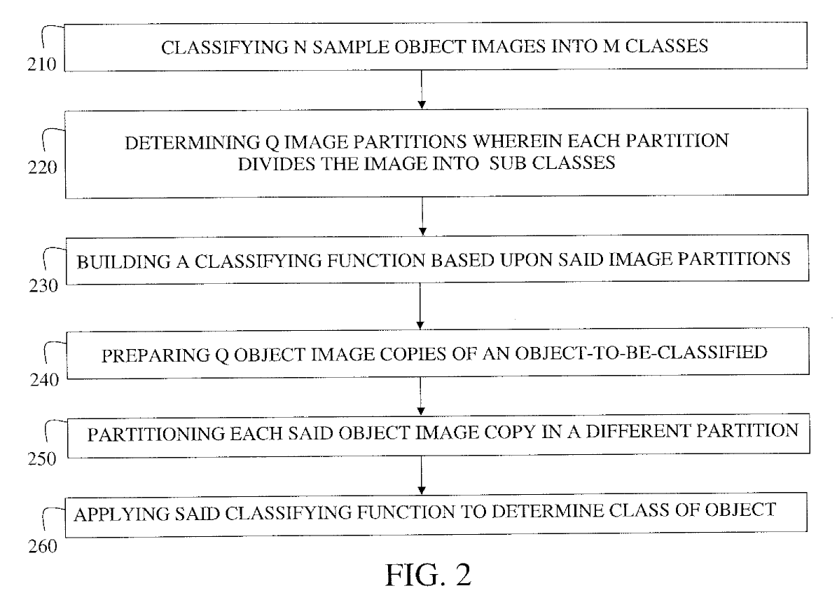

Referring now to FIG. 2, the method according to some embodiments of the present invention is presented in the form of a flowchart. The classifying method begins with classifying N sample object images into M classes 210. Then, Q image partitions are determined wherein each partition corresponds to a different class and each partition divides the image into sub images 220. Usually, Q=M so that each and every class has its own corresponding partition. Using the partitions and the samples classification, a classifying function is built based upon the image partitions, wherein the classifying function is configured to determine the class of an object image presented to it by analyzing its geometric features and statistical information 230. The classifying function may be a function that formulates a relationship between the geometric and statistical features of all the sub images created by the partitions and the set of possible classes.

Whenever a new image is about to be classified using the method according to the invention, Q (which is usually M) object image copies of the object-to-be-classified are prepared 240. Then, each said object image copy is partitioned into sub images, in accordance with said predefined partitions 250. Then, the class of the object to-be-classified is determined by applying the classifying function on data extracted from all the sub images in the partitioned object images copies 260.

According to some embodiments of the invention, the image processing functions may be ready-made and may be imported from a third party functions library.

According to other embodiments of the invention said geometrical and statistical information gathered by image processing functions may include, but not limited to at least one of the following aspects: width, height, area, number of holes, moments of pixel colours, hue, saturation and the like.

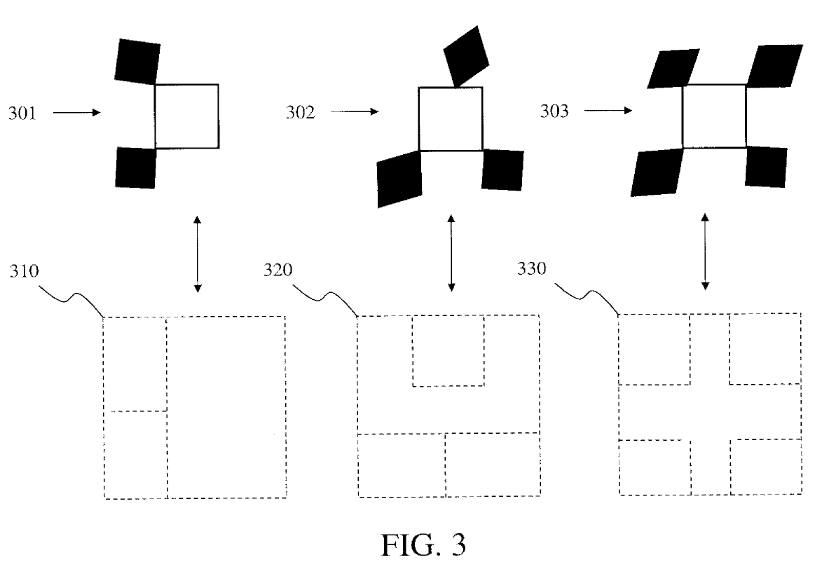

FIG. 3 is an example for applying the method according to the present invention on object A 100. According to this example the number of predefined object classes is three. The classification parameter in this example is the number of rhombuses attached to the rectangle. Accordingly, there are three classes of object A 100 shown: 301, 302 and 303. Each class may represent a plurality of samples, each class having one rhombus, two rhombuses or three rhombuses respectively. The appropriate partition for this example may be in the form of grids 310, 320 and 330 that match the classes 301, 302 and 303 respectively. The classifying function in this example is built and based upon the three grid partitions and the geometrical features and statistical information retrieved from the sub images of each and every corresponding sample class images.

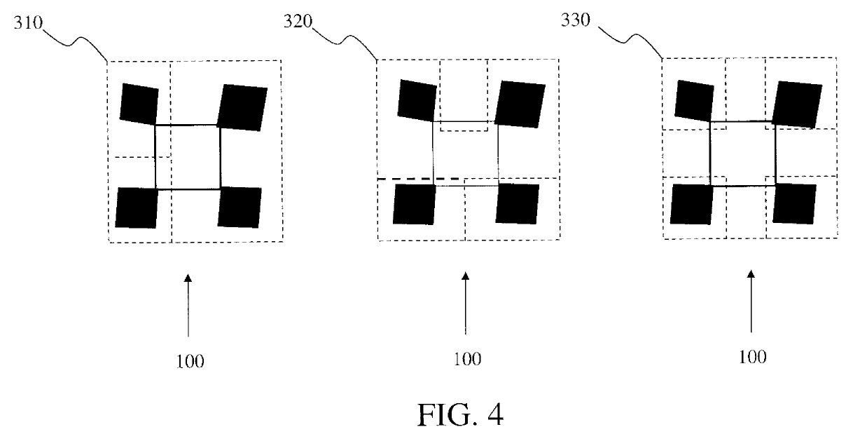

FIG. 4 shows the actual classification process which begins by preparing Q (which is equal to M in this example) copies of object A 100 (three in this example). Subsequently, each copy is partitioned differently, by grids 310, 320 and 330 representing the classes of FIG. 3 301, 302 and 303 respectively. It is the object of the classification example to apply the classifying function and decide now which partition is more likely to divide object A 100 to one white rectangle and 4 black rhombuses, being the class Object A 100 belongs to. As explained above, this object is achieved by applying the classifying function that has been built as explained in the preceding paragraphs. The classifying function shall determine that object A 100 belongs to class 303, which while looking slightly different from object A 100, has too four black rhombus attached to the white rectangle. Furthermore, the information gathered from the geometric and statistical features of other partitions of Object A 100 shall strengthen this decision.

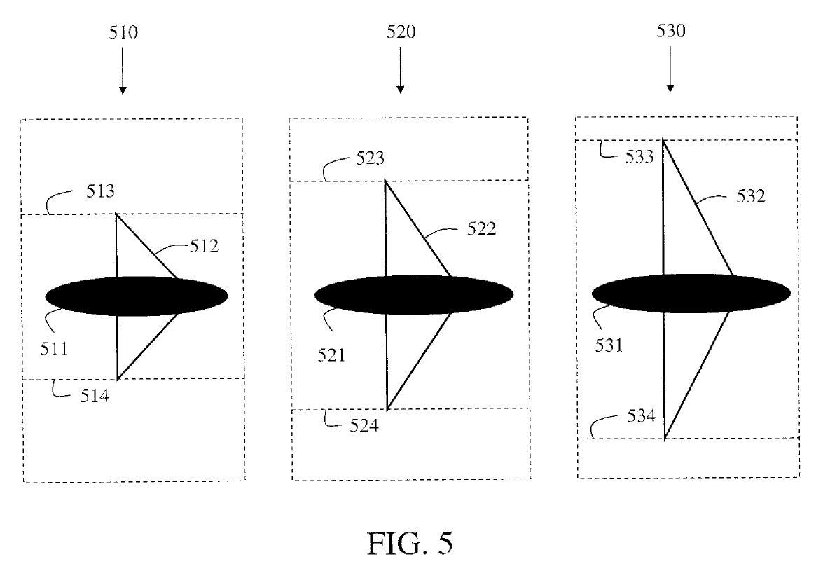

FIG. 5 is another example for the classification method according to the present invention. The object to-be-classified in FIG. 5, Object B, whose predefined classes are 501, 502 and 503 comprises a black ellipsoid 511, 521 and 531 with white triangles having different spans 512, 522 and 532. The classification parameter here is the white triangles span. Hence, the partition derives from the different span of the white triangles in each class and accordingly, the grids 510, 520 and 530 create each three sub images partitioned by two lines each bounding the edges of the white triangles of object B. After determining the partitions, the classifying function is built, again, using the geometric and statistical information retrieved from the sample images and its sub images. Applying each and every partition on a different copy of object B, and then applying the corresponding classifying function shall choose the correct class having the nearest span of white triangle to that of object B.

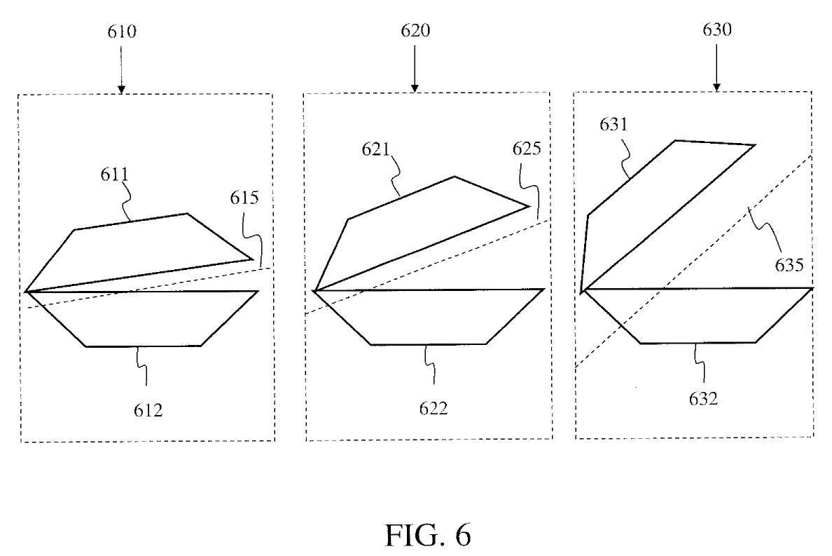

FIG. 6 is yet another example for the classification method according to the present invention is shown. The object to-be classified in FIG. 6, Object C, whose predefined classes are 601, 602 and 603, comprises an upper trapezoid 611, 621 and 631 and a lower trapezoid 612, 622 and 632 with a sharp angle between them. The classification parameter here is the angle between the two trapezoids. Hence, the partition here derives from the different angle in each class and accordingly, the grids 610, 620 and 630 create each two sub images partitioned by a line 615, 625 and 635 which is parallel to the upper trapezoid 611, 621 and 631. After determining the partitions, the classifying function is built, again, using the geometric and statistical information retrieved from the sample images and its sub images. Applying each and every grid of a different copy of object C, together with the appropriate decision function leads to the correct classification of object C.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also he implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out of practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to he commonly understood as by one of ordinary skill in the art to which the invention belongs, unless otherwise defined.

The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the embodiments. Those skilled in the art will envision other possible variations, modifications, and applications that are also within the scope of the invention. Accordingly, the scope of the invention should not be limited by what has thus far been described, but by the appended claims and their legal equivalents. Therefore, it is to be understood that alternatives, modifications, and variations of the present invention are to be construed as being within the scope and spirit of the appended claims.

What is claimed is:

1. A method for classifying objects, said method comprising the steps of:
classifying N sample object images into M classes;
determining Q image partitions wherein each said partition divides the image into sub images;
building a classifying function based upon said image partitions, wherein said classifying function is configured to determine the class of an object image presented to it by analyzing the geometric features and statistical information thereof;
preparing Q object image copies of an object-to-be-classified;
partitioning each said object image copy into P sub images, in accordance with said partitions;
determining the class of the object to-be-classified by applying said classifying function on said partitioned object images copies.

2. The method according to claim 1, wherein Q=M and wherein each partition corresponds to a different class.

3. The method according to claim 1, wherein classifying N sample object images into M classes is performed wherein the N sample object images comprise a plurality of samples for each class M.

4. The method according to claim 1, wherein the classification classifying N sample object images into M classes is performed manually by human beings.

5. The method according to claim 1, wherein partitioning takes into account at least one differentiating parameter from one predefined class to another.

6. The method according to claim 5, wherein said differentiating parameter is at least one of the following: number of predefined sub objects, physical measurements of a sub part, length of a sub object, width of a sub object, area of a sub object, angle between two sub objects.

7. The method according to claim 1, wherein said partitioning in determining Q image partitions divides the image into sub images wherein said sub images are at least one of the following: overlapping, non-overlapping, identical, non-identical, polygonal, non-polygonal.

8. The method according to claim 1, wherein said partitions in determining Q image partitions is in a form of a grid.

9. The method according to claim 1, wherein the partitions in determining Q image partitions comprise each at least two partition lines defining an angle between them.

10. The method according to claim 1, wherein building a classifying function results in a function that formulates a relationship between geometric and statistical features of all the sub images created by the partitions and the set of possible classes.

11. The method according to claim 10, wherein said classifying function is a generated by a learning algorithm.

12. The method according to claim 10, wherein said classifying function employs at least one of the following techniques: neural networks, support vector machines, decision trees.

13. The method according to claim 1, wherein said geometric features and statistical information are retrieved from said image copies and said sub images by using image processing functions.

14. The method according to claim 13, wherein said image processing functions include one of the following aspects: width, height, area, number of holes, moments of pixel colours, hue, saturation, luminance.

15. The method according to claim 13, wherein said image processing functions are imported from at least one third party image processing functions library.

16. The method according to claim 1, wherein building a classifying function is performed again after determining the class of the object to-be-classified, wherein feedback regarding the success of said classifying is used to improve said classifying function.

17. An apparatus for classifying objects, said apparatus comprising:
means for classifying N sample object images into M classes;
means for determining Q image partitions wherein each said partition divides the image into sub images;
means for building a classifying function based upon said image partitions, wherein said classifying function is configured to determine the class of an object image presented to it by analyzing the geometric features and statistical information thereof;
means for preparing Q object image copies of an object-to-be-classified;
means for partitioning each said object image copy into P sub images, in accordance with said partitions; and
means for determining the class of the object to-be-classified by applying said classifying function on said partitioned object images copies.

18. The apparatus according to claim 17, wherein Q=M.

19. The apparatus according to claim 17, wherein determining Q image is performed according to at least one of the following differentiating parameters: number of predefined sub objects, physical measurements of a sub part, length of a sub object, width of a sub object, area of a sub object, angle between two sub objects.

20. The apparatus according to claim 17, wherein said means for determining the class of the object to-be-classified is implemented with parallel hardware.
